(19) United States
(12) Patent Application Publication
(10) Pub. No.: US 2012/0310875 A1
(43) Pub. Date: Dec. 6, 2012

(54) METHOD AND SYSTEM OF GENERATING A DATA LINEAGE REPOSITORY WITH LINEAGE VISIBILITY, SNAPSHOT COMPARISON AND VERSION CONTROL IN A CLOUD-COMPUTING PLATFORM

(76) Inventors: Prashanth Prahlad, Fremont, CA (US); Subhajit Purkayastha, Fremont, CA (US); Sekhar Kizhekke Variam, Santa Cruz, CA (US); Venkateshwara R. Thotakura, Fremont, CA (US); Viswanathan Chandrasekaran, Los Altos, CA (US)

(21) Appl. No.: 13/287,296

(22) Filed: Nov. 2, 2011

Related U.S. Application Data
(60) Provisional application No. 61/493,284, filed on Jun. 3, 2011.

(51) Int. Cl. G06F 17/30

(52) U.S. Cl. 707/602; 707/E17.005

(57) ABSTRACT

In one exemplary embodiment, a computer-implemented method of a database management system including the step of obtaining a metadata about a data from a metadata source. The metadata is converted to an extensible markup language (XML). XML variant or text formatted file. The formatted file is uploaded to a central repository. The formatted file is parsed to acquire information about the data. A data structure that includes the information about the data is generated. The data structure can be stored in a database cluster resident in a cloud computing platform. The metadata source can be an extract, transform and load (ETL) server or a data warehouse server. A dashboard visualization of the data lineage information can be rendered for display with a graphical user interface.

### CROSS-REFERENCE TO RELATED APPLICATIONS

This application claims priority from U.S. Provisional Application No. 61/493,284, filed Jun. 3, 2011, entitled METHOD AND SYSTEM OF GENERATING A DATA LINEAGE REPOSITORY WITH LINEAGE VISIBILITY AND VERSION CONTROL IN A CLOUD COMPUTING PLATFORM. The provisional application is hereby incorporated by reference in its entirety.

### BACKGROUND OF THE INVENTION

1. Field

This application relates generally to database management, and more specifically to a system and method for generating a data lineage repository with lineage visibility, snap shot comparison and version control in a cloud-computing platform.

2. Related Art

A data warehouse can consolidate and integrate information from many internal and external sources and arrange it in a meaningful format for making accurate and timely business decisions. Thus, a data warehouse can be used to executives, managers and business analysts in making complex business decisions through applications such as an analysis of trends, target marketing, competitive analysis, customer relationship management and so on.

Additionally, many business applications can utilize cloud-computing methodologies. Cloud computing can include the delivery of computing as a service rather than a product, whereby shared resources, software, and information are provided to computers and other devices as a utility over a network.

Thus, a method and system are desired for system and method for generating a data lineage repository with lineage visibility and version control in a cloud-computing platform to improve beyond existing methods of data warehousing,

### BRIEF DESCRIPTION OF THE DRAWINGS

The present application can be best understood by reference to the following description taken in conjunction with the accompanying figures, in which like parts may be referred to by like numerals.

FIG. 1 shows, in a block diagram format, an example illustrating a system of providing data lineage visibility and version control, according to some embodiments.

FIG. 2 illustrates an exemplary process for generating a data lineage repository in a cloud-computing platform.

FIG. 3 illustrates an example central repository (e.g. a example version of data lineage repository) according some embodiments.

FIG. 4 illustrates an example central repository client residing in a customer environment.

FIG. 5 illustrates a sample computing environment that can be utilized in some embodiments.

FIG. 6 depicts computing system with a number of components that may be used to perform the above-described processes.

### BRIEF SUMMARY OF THE INVENTION

In one exemplary embodiment, a computer-implemented method of a database management system including the step of obtaining a metadata about a data from a metadata source. The metadata is converted to an extensible markup language (XML), XML variant or text formatted file. The formatted file is uploaded to a central repository. The formatted file is parsed to acquire information about the data. A data structure that includes the information about the data is generated. The data structure can be stored in a database cluster resident in a cloud computing platform. The metadata source can be an extract, transform and load (ETL) server or a data warehouse server. A dashboard visualization of the data lineage information can be rendered for display with a graphical user interface.

### DETAILED DESCRIPTION

The following description is presented to enable a person of ordinary skill in the art to make and use the various embodiments. Descriptions of specific devices, techniques, and applications are provided only as examples. Various modifications to the examples described herein will be readily apparent to those of ordinary skill in the art, and the general principles defined herein may be applied to other examples and applications without departing from the spirit and scope of the various embodiments. Thus, the various embodiments are not intended to be limited to the examples described herein and shown, but are to be accorded the scope consistent with the claims.

A. Environment and Architecture Overview

Disclosed are a system, method, and article of manufacture for generating a data lineage repository with lineage visibility and version control in a cloud-computing platform. Although the present embodiments have been described with reference to specific example embodiments, it will be evident that various modifications and changes may be made to these embodiments without departing from the broader spirit and scope of the various claims.

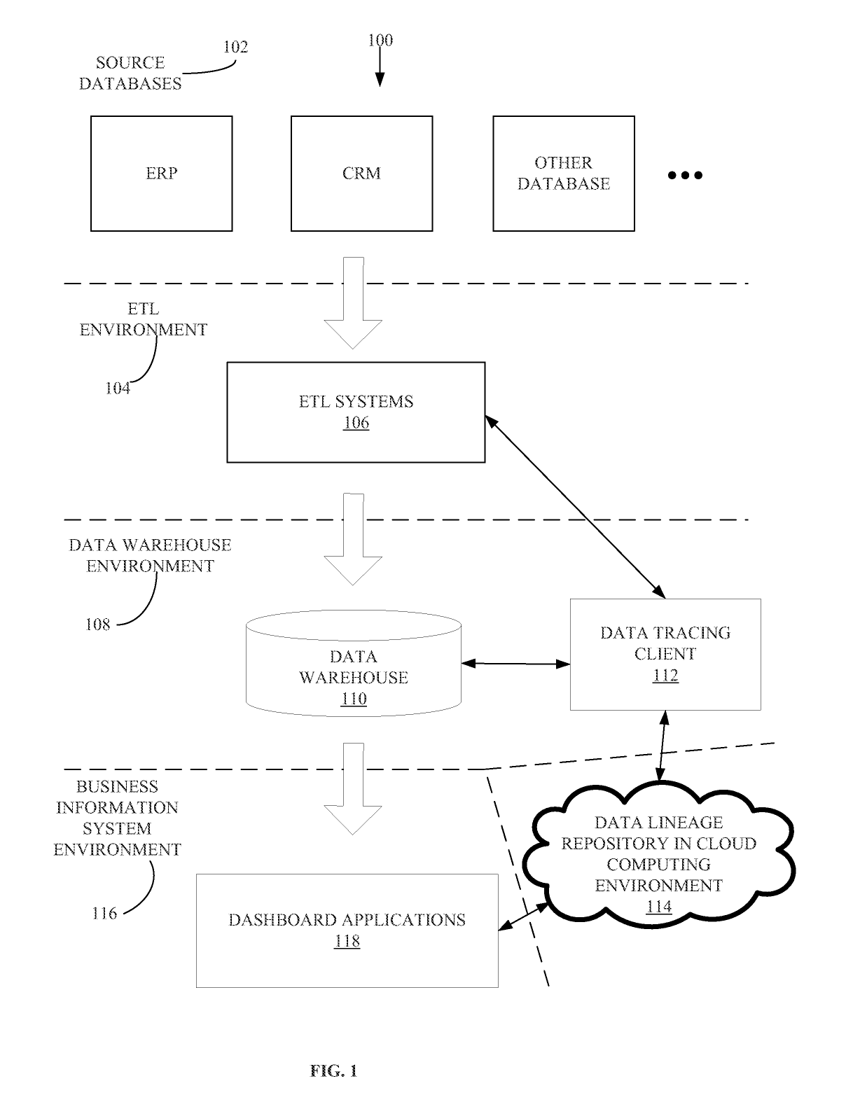

FIG. 1 shows, in a block diagram format, an example illustrating a system 100 of providing data lineage visibility and version control, according to some embodiments. As used herein, data lineage can include information pertinent to data tracing, tracking, versioning, change control of data from data sources through extraction, transformation and loading (ETL) processing, logical warehouse processing, presentation model processing and/or processor layer processing. Data lineage can also include data transformation information, metadata information and/or data source information, data historical information, metadata transformation history and the like. As used herein, version control can include enablement of full visibility of the stored metadata (e.g. the data lineage data as described supra). For example, version control can include the enablement to view multiple ‘snapshots’ of meta data of various environments in the data warehousing process (e.g. from ETL to Dashboards). Version control can also include the enablement of comparison of two or more ‘snapshots’. This can include the display of differences (e.g. additions, deletions and changes) from one snapshot to another snapshot. Exemplary differences that can be displayed can include such information as ETL operations, logical layer data, physical layer data (e.g. data warehouse data), dashboard data, various ETL and data warehouse analytical and reporting data, and the like. Examples of some of these version control views are provided in Appendix A of United States Provisional Application 61/493,284. System 100 can visualize the data lineage for administrators with a dashboard 118. Moreover, in some example embodiments, system 100 can provide complete versioning, tracking and change control for various propriety data warehouse technologies. As used herein, the term “metadata” refers generally to data that defines other data In the context of data warehousing, the term “metadata.” refers to data that defines data that is stored in a source database or in a data warehouse. For example, in the context of data warehousing, metadata may include the database schema used in a source database or in a data warehouse. Metadata may define not only the final data that is stored in the data warehouse, but also intermediate data and structures, such as data about ETL processing, logical warehouse processing, presentation model processing and/or presentation layer processing.

Source databases 102 can include any database that provides data to a data warehouse. For example, source databases 102 can include an enterprise resource planning (ERP) database, a CRP database and the likes. In some examples, source databases 102 can include multiple operational online transactional processing (OLTP) data sources.

Data warehousing technologies can include one or more ETL systems 106 of the En environment 104. Generally, ETL systems 106 can generally extract data from source databases 102, transform the data to conform to the operational needs of data warehouse 110, and then load the data into data warehouse 110. The data extraction operation can typically include the process of retrieving data out of data sources 102 for further data processing and/or data storage (including data migration). The import operation into the intermediate extracting system can be followed by data transformation and the addition of metadata prior to export to another stage in the data workflow. In some embodiments, ETL system 106 can include parsing functionalities that parse and check the ex acted data to ensure that it meets certain criteria before the data is moved to the next stage of the data workflow as well. Extraction operations can include techniques to add structure to unstructured data as well if the data is extracted from an unstructured data source. Any metadata generated by extraction operations can be provided to data tracing client 112 described infra.

The data transformation process can include apply a series of rules and/or functions to the extracted data from the source to derive the data for loading into an end target such as data warehouse 110. Data transformation rules and/or function can be modulated to accommodate the extracted data. For example, some data sources may require very little or even no manipulation of data. Other data sources may require various transformation operations. Exemplary transformation operations include, inter alia, selecting only certain columns to load (or selecting null columns not to load), encoding free-form values (e.g., mapping “Male” to “1” and “Mr” to M), sorting operations, joining data from multiple sources (e.g., lookup, merge), data aggregation operations, generating surrogate-key values, disaggregation of repeating columns, and the like. The transformation process can also include rephrasing operations on the data. Additionally, in some embodiments, various languages can be utilized for perform data transformation such as AWK, XSLT and/or TXL. The load phase loads the data into the end target, usually data warehouse 110. The load process can vary according to the parameters and schema of data warehouse 110.

In some embodiments, ETL systems 106 can also acquire and generate metadata about the data as well. Moreover, metadata can be generated about the various ETL operations that have been performed on the respective data. All these types of metadata can be provided to data tracing client 112.

Data warehousing technologies can include one or more data warehouses 110 of data warehouse environment 108. For example, data warehouse 110 can be a database that stores information from other databases using a common format (e.g. using the ETL systems and operations described supra). Generally, data warehouse 110 can include systems for responding to queries about data (e.g. can include a data mart, can interact with and/or include a business information systems environment 116 and the like—see infra). Generally, a data warehouse is a centralized collection of data. Data warehouses are ideally suited for supporting management decision-making in business organizations since data from disparate and/or distributed sources may be stored and analyzed at a central location. For example, a financial services organization may store and aggregate in a data warehouse large amounts of financial data obtained from its regional office databases around the world. Various analytical and reporting tools (e.g. OLAP, ROLAP, MOLAP, and the like) may then be included to process the aggregated data to present a coherent picture of business conditions at a particular point in time, and thereby support management decision making of the organization.

Data warehouses are typically implemented on a database management system (DBMS) that includes a large database for storing the data, a database server for processing queries against the database and one or more database applications for accessing the DBMS. The types of applications that are provided for a data warehouse vary widely, depending upon the requirements of a particular implementation. For example, a data warehouse may include an application for configuring the database schema used for the data warehouse database. As another example, a data warehouse may include an application for extra ling data from source databases and then storing the extracted data in the data warehouse. A data warehouse may also include an application for generating reports based upon data contained in the data warehouse. In some embodiments, data warehouse can be a proprietary ‘pre-built’ data warehouses such as SAP DW, Oracle BI Analytic Apps (OBIA), and the like.

In some embodiments, business information system environment 116 can include end-user analysis tools for examining data warehouse information and/or the data lineage information in data lineage repository, 114. Typically, the analysis tools can reside on a customer's computer. For example, data warehouse 110 can interact business information systems environment 116 that includes means for presenting data to a user (e.g. a systems administrator, a business analyst). Moreover, data lineage repository 114 can provide dashboard applications 118 to business information systems environment 116 as well. Dashboard applications can include one or more dashboards visualizations of data lineage of any data of FIG. 1. Furthermore, in some examples, a dashboard can include a concise set of high-level graphical views into data warehouse 110 and/or a database in the data lineage repository 114 (e.g. see APPENDIX A of U.S. Provisional Application 61/493,284), enabling executive-level management to analyze specific aspects of their organization and/or (in the case of data lineage repository (14) the data flow to data warehouse 110. Each dashboard can include visualized summarizations of data (e.g. charts). For example, within a chart, the data may be further analyzed by selecting data labels within the chart and clicking to drill down into more detail. Exemplary dashboards can also provide a set of standard controls, such as dropdown boxes, buttons, and/or radio buttons through which a user (such as a customer and/or a database system administrator) can request information from the data lineage repository 114. Additionally, data lineage repository 114 can provide other visualizations (rendered as user interfaces) such as comparison reports, lineage reports, database administration screens, snap shots of data history at specified periods in the data flow, reports about information between metadata, and the like.

A software agent such as data tracing client 112 can also reside in the data warehouse environment 108 as shown (e.g. on a data warehouse server). However, it should be noted, that in other example embodiments, the software agent can reside at the ETL environment 104 (e.g. on an ETL server), source databases 102 and/or in the business information system environment 116 (e,g. on a business intelligence server such as an Oracle BI (OBIEE) server). Data tracing client 112 and data lineage repository 114 can provide visibility of data transformations from the source (e.g. source databases 102) to the destination (e.g. data warehouse 110) in various data warehouse technologies. Moreover, data tracing client 112 and data lineage repository 114 can provide complete versioning, tracking and change control for all leading proprietary data warehouse technologies. Accordingly, data tracing client 112 can mine any layer of the data collection, migration and presentation process for metadata. For example, data tracing client 112 can acquire metadata information about the data and/or operations performed on the data from data sources 102, ETL systems 106, data warehouse 110 and/or business information system environment 116. Data tracing client 112 (or in some embodiments data lineage repository 114) can then convert this metadata into a parseable format such as an extensible markup language (XML) format and/or any XML variant format (and in some embodiments into text). Data tracing client 112 can then upload this information to data lineage repository 114. Data lineage repository 114 can parse the converted metadata. The parsed converted metadata can then be provided as data structures accessible in a database managed by data lineage repository 114 via a cloud-computing environment (e.g. Amazon's Elastic Compute Cloud (EC2)). A user (e.g. a person using analysis tools to obtain data lineage information) can access the data lineage repository 114 to obtain data lineage information. For example, data lineage information can be included into dashboard applications 118. Exemplary descriptions of these algorithms, systems and operations are provided below.

B. Operation Overview

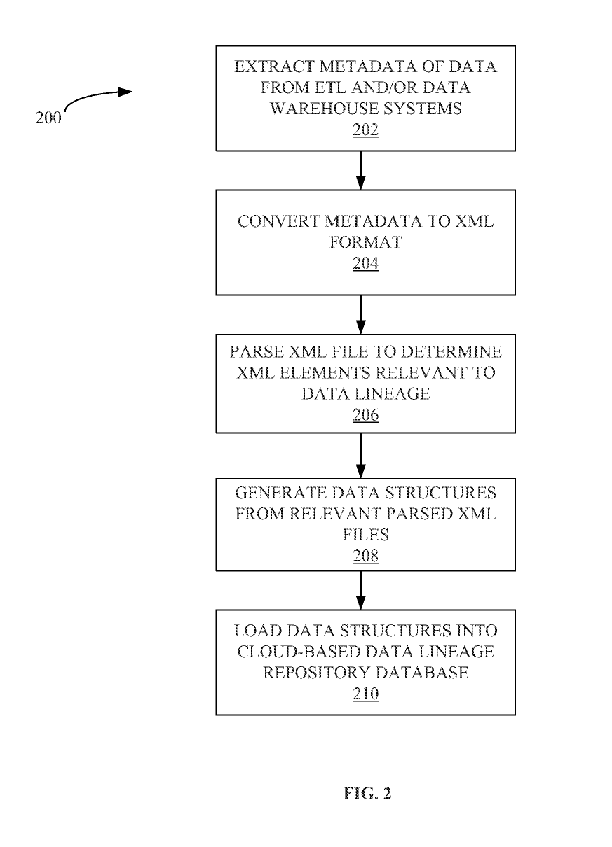

FIG. 2 illustrates an exemplary process for generating a data lineage repository in a cloud-computing platform. In step 202 of process 200, metadata is extracted from ETL and/or data warehouse systems. For example, a client can reside in the respective ETL and/or data warehouse system. The client can extract metadata from EEL and/or data warehouse repositories. The metadata can be relevant to data lineage. In step 204 of process 200, the extracted metadata can be converted to an XML (or similar) format. For example, the client can perform the metadata conversion operations. In some embodiments, the converted metadata XML files can be communicated to a central repository in a cloud-computing platform with an FTP/HTTP protocol. The central repository can maintain a file system of XML files. In step 206 of process 200, the XML files can be parsed to determine the XML elements relevant to data lineage. For example, a metadata processor can process the metadata and classify it into various categories that are relevant to the data lineage. In step 208 of process 200, data structures can be generated from the parsed XML files. These data structures can be loaded into a database in a cloud computing platform in step 210 (e,g, as a metadata database cluster), and thus be easily accessible to customer machines (e.g. via a user interface agent and/or a reporting server). For example, in some embodiments, the XML metadata can also be formatted for visualization and communicated using a secure protocol (e.g. with an HTTP, HTTPS, EPS or similar protocol or provided on a secure flash drive, and the like) to a customer machine.

C. Additional Features and Processes

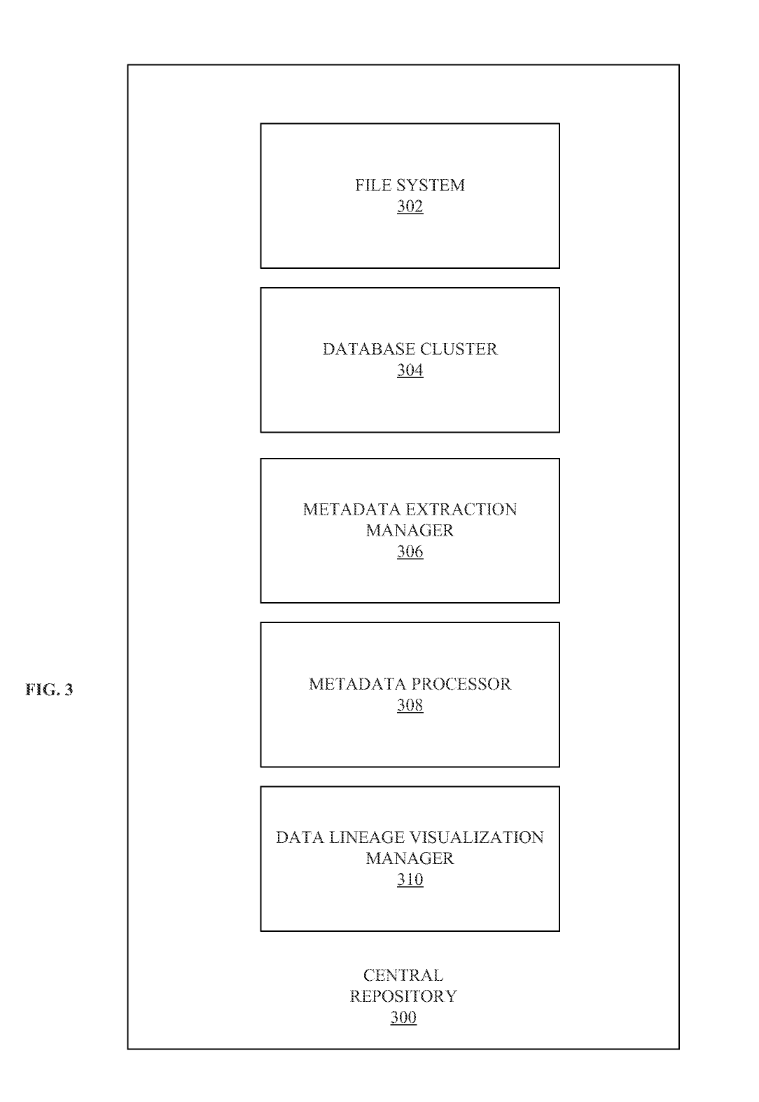

FIG. 3 illustrates an example central repository 300 (e.g. a example version of data lineage repository 114) according some embodiments. In some embodiments, central repository 300 and its various components can reside in a cloud-computing platform such as an Amazon EC2 cloud-computing platform. Central repository 300 can include a file system 302. File system 302 can receive ETL and/or data warehouse XML files (or similar formats such as a text file) from a remote client in an ETL and/or data warehouse system. Database cluster 304 can include data structures generated from the processed WI, files. These data structures can include data lineage information. In some embodiments, data cluster 304 can be a relational database that consists of tables connected to each other based on several criteria. For example, there can be identifiers for customer, security, environments, snapshots, relationship between the metadata etc.

Central repository 300 can include components for generating the database cluster 304. For example, metadata extraction manager 306 can communicate with client applications and request periodic uploads of metadata relevant to data lineage. In various embodiments, Metadata extraction manager 306 can pull metadata on an ‘as needed’ basis, a preset periodic basic and/or a near real-time basis (assuming networking and processing latencies) based on such factors as system settings, metadata source type, customer requests and the like. Metadata extraction manager 306 can organize the received files in file system 302. Metadata processor 308 can then parse the XML files and generate the data structures of database cluster 304. Parsing algorithms can be adapted to various customer formats. Data lineage visualization manager 310 can provide an interface for customer machines to access database cluster 304. The interface can include data lineage information as well as other relevant data such as comparison reports and database administration reports. For example, data lineage visualization manager 310 can provide this information in a format accessible by dashboard applications (via an HTTPS protocol) in the customer machine. Data lineage visualization manager 310 can include a reporting server that provides data lineage reports to customer machines and/or database system administrators. In an example embodiment, the reporting server can generate ‘ad-hoc reports in response to customer queries.

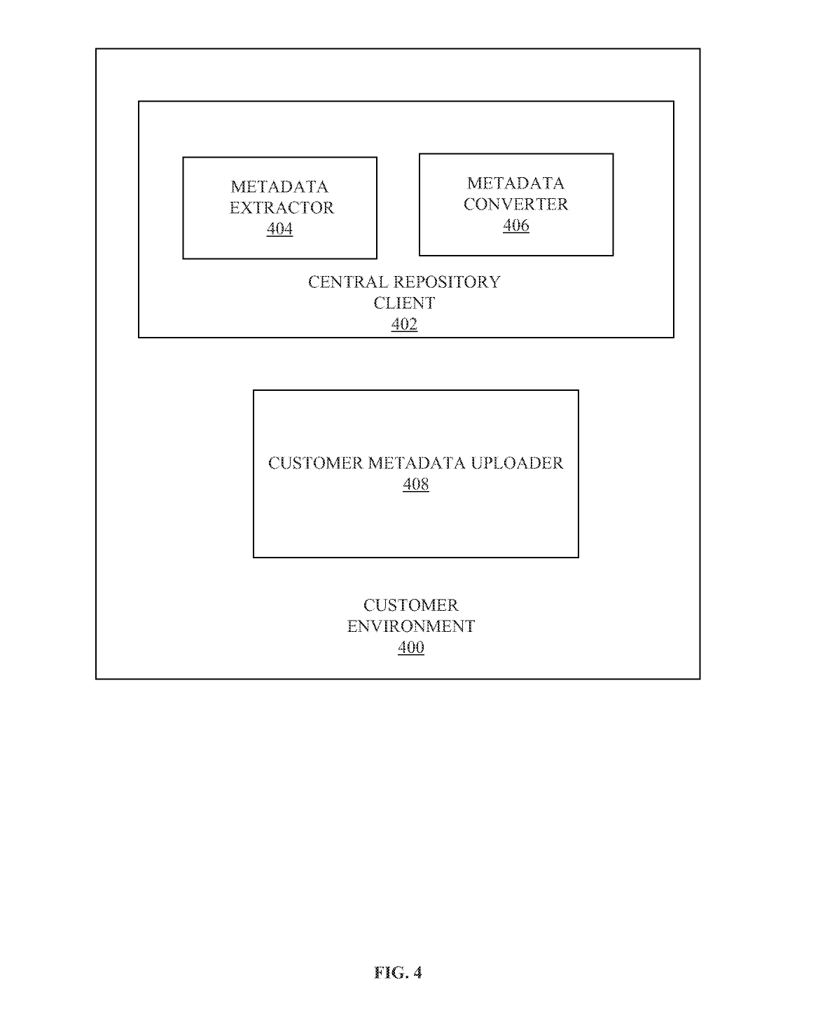

FIG. 4 illustrates an example central repository client 402 residing in a customer environment 400. Customer environment 400 can include any business intelligence system such as those shown in the system of FIG. 1. Example customer environments include systems that perform ETL processing, logical warehouse processing, presentation model processing and/or presentation layer processing. According to various embodiments, central repository client 402 can be modified to operate in the environments of various proprietary customer systems. For example, central repository client 402 can be modified to operate in specific proprietary ETL environments such an Informatica® version 8.0 and/or another variant for Informatica® version 9.0. Moreover, central repository client 402 can be modified to operate in specific proprietary data warehouse environments as well. Central repository client 402 can include a metadata extractor 404 configured to obtain metadata about the data in the customer environment 400. Metadata extractor 404 can interface with a customer metadata uploader 408 that provide the metadata. Example customer metadata uploaders include ETL metadata uploaders, logic warehousing metadata uploaders, presentation model metadata uploaders, and/or processor layer metadata uploaders. Once the metadata has been provided, metadata converter 406 can then parse and convert the metadata to a specified format (e.g. XML, text and the like) and render the converted metadata for transport to a central repository using a specified transport protocol (e.g. file transport protocol (FTP), hypertext transport protocol (HTTP), and the like).

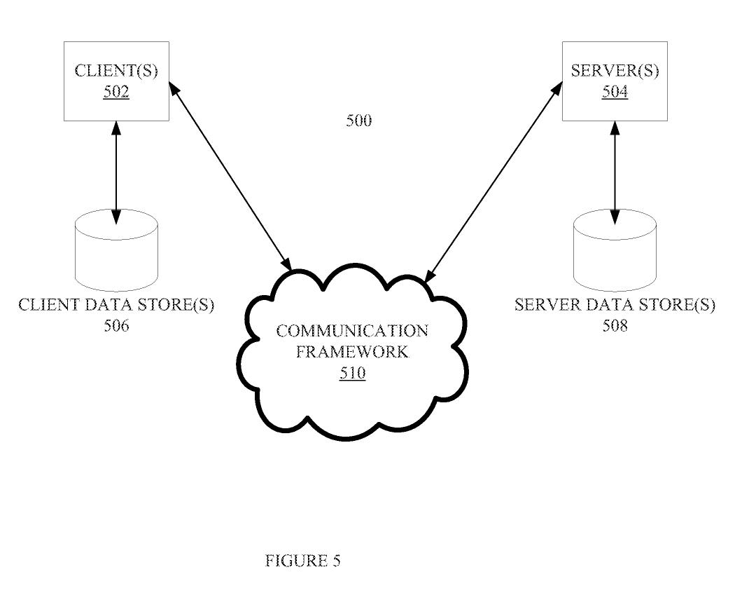

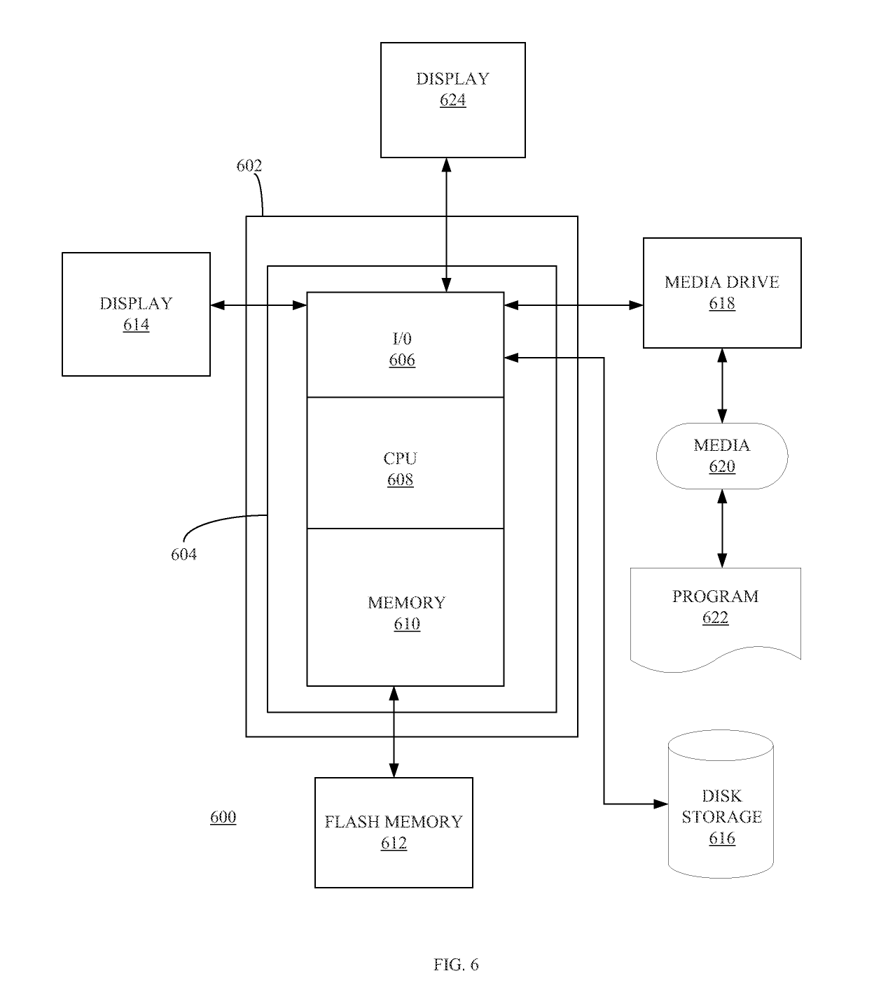

FIG. 5 and FIG. 6 provide exemplary computing environments, devices and architectures for the implementation of the various embodiments discussed herein.

FIG. 5 illustrates a sample computing environment 500 that can be utilized in some embodiments. The system 500 further illustrates a system that includes one or more client(s) 502. The client(s) 502 can be hardware and/or software (e.g., threads, processes, computing devices). The system 500 also includes one or more server(s) 504 (e.g., the web server discussed supra). The server(s) 504 can also be hardware and/or software (e.g., threads, processes, computing devices). One possible communication between a client 502 and a server 504 may be in the form of a data packet adapted to be transmitted between two or more computer processes. The system 500 includes a communication framework 510 that can be utilized to facilitate communications between the client(s) 502 and the server(s) 504. The client(s) 502 are connected to one or more client data store(s) 506 that can be employed to store information local to the client(s) 502. Similarly, the server(s) 504 are connected to one or more server data store(s) 508 that can be employed to store information local to the server(s) 504.

FIG. 6 depicts an exemplary computing system 600 that can be configured to perform any one of the above-described processes. In this context, computing system 600 may include, for example, a processor, memory, storage, and I/O devices (e.g., monitor, keyboard, disk drive, Internet connection, etc.). However, computing system 600 may include circuitry or other specialized hardware for carrying out some or all aspects of the processes. In some operational settings, computing system 600 may be configured as a system that includes one or more units, each of which is configured to carry out some aspects of the processes either in software, hardware, or some combination thereof.

FIG. 6 depicts computing system 600 with a number of components that may be used to perform the above-described processes. The main system 602 includes a motherboard 604 having an I/O section 606, one or more central processing units (CPU) 608, and a memory section 610, which may have a flash memory card 612 related to it. The I/O section 606 is connected to a display 624, a keyboard 614, a disk storage unit 616, and a media drive unit 618. The media drive unit 618 can read/write a computer-readable medium 620, which can contain programs 622 and/or data.

At least some values based on the results of the above-described processes can be saved for subsequent use. Additionally, a computer-readable medium can be used to store (e,g., tangibly embody) one or more computer programs for perforating any one of the above-described processes by means of a computer. The computer program may be written, for example, in a general-purpose programming language (e.g., Pascal, C, C++, Java) or some specialized application-specific language.

Optionally, it should be noted, that the order of the sequence of the various methods described herein can be modified (e.g. reversed) such that an administrator can create or copy complete code modules from various sources such as those described supra in FIG. 1 (e.g. ETL systems 106, data warehouse 110, and/or dashboard applications 118) in order to automate software code development in a data warehousing application.

Furthermore, the methods and systems (e.g. dashboard applications 118 of FIG. 1 supra) described herein can be configured to present dashboard compatible for mobile devices like smartphones and tablet computers (e.g. using an mobile operating system such as an iOS® or an Android® based operating system). Thus, lineage and version comparison information from a cloud-based platform could then be displayed and interacted with by an administrator using the mobile device. Optionally, the application could be used while the application is in an online mode (e.g. connected to the interact) and/or in an offline mode (e.g. not connected to the internet). For example, if the application is an offline mode, the application can be automatically synced up with an online server at a later time such as when a sufficient Internet connection is reestablished.

D. Conclusion

Although the present embodiments have been described with reference to specific example embodiments, various modifications and changes can be made to these embodiments without departing from the broader spirit and scope of the various embodiments. For example, the various devices, modules, etc. described herein can be enabled and operated using hardware circuitry, firmware, software or any combination of hardware, firmware, and software (e.g., embodied in a machine-readable medium).

In addition, it will be appreciated that the various operations, processes, and methods disclosed herein can be embodied in a non-transitory machine-readable medium and/or a machine accessible medium compatible with a data processing system (e.g., a computer system), and can be performed in any order (e.g., including using means for achieving the various operations). Accordingly, the specification and drawings are to be regarded in an illustrative rather than a restrictive sense. In some embodiments, the machine-readable medium can be a non-transitory form of machine-readable medium.

What is claimed as new and desired to be protected by Letters Patent of the United States is:

1. A computer-implemented method of a database management system comprising:
Obtaining, with a server, a metadata with information about a data from a metadata source;
converting the metadata to an extensible markup language (XML), XML variant or text formatted file;
uploading the formatted tile to a central repository;
parsing the formatted file to acquire information about the data; and
generating a data structure, wherein the data structure comprises the information about the data.

2. The computer-implemented method of claim 1 further comprising:
storing the data structure in a database cluster resident in a cloud computing platform.

3. The computer-implemented method of claim 2, wherein the metadata source comprises an extract, transform and load (ETL) server.

4. The computer-implemented method of claim 2, wherein the metadata source comprises a data warehouse server.

5. The computer-implemented method of claim 1, wherein the data structure comprises data lineage information about the data.

6. The computer-implemented method of claim 1 further comprising:
rendering a dashboard visualization of the data lineage information.

7. The computer-implemented method of claim 1 further comprising:
generating a data lineage report from the extracted metadata.

8. The computer-implemented method of claim 7, wherein the data lineage report comprises information about a data transformation that occurred in the ETL server.

9. The computer-implemented method of claim 7, wherein the data lineage report comprises information about a data transformation that occurred in the data warehouse server.

10. The computer-implemented method of claim 7, wherein the data lineage report comprises a comparison of the data in at least two locations of a migration of the data from a data source to a data warehouse,

11. The computer-implemented method of claim 1, wherein the step of converting the metadata to an extensible markup language (XML) formatted file further comprises:
converting the metadata into a text tile.

12. The computer-implemented method of claim 1, wherein the metadata comprises data lineage data of the data.

13. A computer readable medium comprising non-transitory computer executable instructions adapted to perform the computer-implemented method of claim 1.

14. A data lineage management system comprising:
a metadata extraction manager configured to obtain metadata from a remote client;
a metadata processor configured to convert the metadata to a markup language and to upload a formatted file of the metadata to a database cluster in a cloud computing platform; and
a data lineage visualization manager configured to generate an interface for a customer machine to access a database cluster information, and wherein the database cluster information comprises a data lineage information.

15. The system of claim 14, wherein the remote client is located in a database server of a source database, a data staging area server or a data warehouse server.

16. The system of claim 15, wherein the metadata comprises extract-transform-load process (ETL) data or a data warehouse extensible markup language (XML) file.

17. The system of claim 16, wherein the metadata comprises data about the data lineage of a set of data.

18. The system of claim 17,
wherein the data lineage information can be visualized with a graphical user interface of the customer machine, and
wherein data lineage can include information pertinent to a data tracing operation, data tracking operation, a operation versioning operation, a operation related to change control of data from data sources through ETL processing, a logical warehouse processing operation, a presentation model processing operation or process layer processing operation.

19. The system of claim 18, wherein the markup language comprises an extensible markup language (XML).

20. The system of claim 19, wherein the data lineage visualization manager can generate an ad-hoc report in response to a query from the customer machine.
